(19) United States
(12) Patent Application Publication
(10) Pub. No.: US 2025/0384219 A1
(43) Pub. Date: Dec. 18, 2025

(54) NON-TRANSITORY COMPUTER-READABLE STORAGE MEDIUM AND PROMPT MESSAGE GENERATING METHOD

(71) Applicant: DELTA ELECTRONICS, INC., Taoyuan City (TW)

(72) Inventors: Zheng-Bang LIU, Taoyuan City (TW); Yi-Ying TSENG, Taoyuan City (TW)

(21) Appl. No.: 19/200,707

(22) Filed: May 7, 2025

(30) Foreign Application Priority Data
Jun. 13, 2024 (CN) 202410758338.7

(51) Int. Cl. G06F 40/40; G06F 40/279; G06F 40/30

(52) U.S. Cl. CPC G06F 40/40; G06F 40/279; G06F 40/30

(57) ABSTRACT

A non-transitory computer-readable storage medium storing one or more computer programs is disclosed. The one or more computer programs can be performed by one or more processors to perform: obtaining at least one key information based on an input content message and a predefined rule, and generating at least one task prompt according to the at least one key information; obtaining a format requirement information according to the predefined rule, and analyzing the input content message to obtain a semantic requirement information; retrieving at least one example data from a text example database according to the semantic requirement information, and processing the at least one example data according to the format requirement information to generate at least one task example; and synthesizing the input content message, the at least one task prompt and the at least one task example to generate a prompt message.

### CROSS-REFERENCE TO RELATED APPLICATION

This application claims priority to Chinese Application Serial Number 202410758338.7, filed Jun. 13, 2024, which is herein incorporated by reference in its entirety.

### BACKGROUND

### Field of Disclosure

The present disclosure relates to a non-transitory computer-readable storage medium and a prompt message generating method. Specifically, the present disclosure relates to a non-transitory computer-readable storage medium and a prompt message generating method that automatically generates prompt messages.

### Description of Related Art

When the number of parameters in a language model reaches the scale of billions, it is referred to as a Large Language Model (LLM). Compared with traditional pre-trained models (e.g., BERT), the output content of a Large Language Model is further diversified, therefore it is often necessary to add “prompt” to guide the model in generating results that better meet the requirements.

In the situation when a Large Language Model (LLM) is integrated into an application, an appropriate prompt needs to be customized and designed according to the specific application requirements. Traditionally, prompts are designed manually. However, it is difficult to find the optimal prompt manually. Furthermore, once a prompt is created, it is rarely modified. When the core Large Language Model of the application is updated, all prompt performance needs to be re-evaluated. If the performance is not good enough, manual fine-tuning is required.

Therefore, how to provide a technology that can automatically generate prompt messages is an urgent goal that the industry needs to strive for.

### SUMMARY

The disclosure provides a non-transitory computer-readable storage medium. The non-transitory computer-readable storage medium stores one or more computer programs, and the one or more computer programs can be performed by one or more processors to perform a prompt message generating method, in which the prompt message generating method includes the following operations: obtaining at least one key information based on an input content message and a predefined rule, and generating at least one task prompt according to the at least one key information; obtaining a format requirement information according to the predefined rule, and analyzing the input content message to obtain a semantic requirement information; retrieving at least one example data from a text example database according to the semantic requirement information, and processing the at least one example data according to the format requirement information to generate at least one task example; and synthesizing the input content message, the at least one task prompt and the at least one task example to generate a prompt message.

The disclosure provides a prompt message generating method. The prompt message generating method includes the following operations: obtaining at least one key information based on an input content message and a predefined rule, and generating at least one task prompt according to the at least one key information; obtaining a format requirement information according to the predefined rule, and analyzing the input content message to obtain a semantic requirement information; retrieving at least one example data from a text example database according to the semantic requirement information, and processing the at least one example data according to the format requirement information to generate at least one task example; and synthesizing the input content message, the at least one task prompt and the at least one task example to generate a prompt message.

The prompt message generation technology provided by the embodiments of the present disclosure (including at least non-transitory computer-readable storage medium and methods) automatically generates prompt messages for Large Language Models based on input content messages and predefined rules. The embodiments of the present disclosure eliminate the need for manual creation of prompt messages and manual selection of prompt examples, which reduces the frequency of fine-tuning prompt messages based on applications, and thereby accelerates the development of text-related applications. Furthermore, the embodiments of the present disclosure can be applied to any text-related application projects with Large Language Model as the core engine, speeding up the application development process. And for advanced applications in the text field, such as intelligent question and answer, chat robots, through automatically generated prompt messages, users can feel that they are not following rigid rule-based robots or can chat closely integrated with the application scenario, and the user experience is improved.

The detailed technology and implementation of the present invention will be described below in reference to the drawings, so that those skilled in the art to which the present invention belongs can understand the technical features of the claimed invention.

### BRIEF DESCRIPTION OF THE DRAWINGS

FIG. 1 is a schematic diagram illustrating a prompt message generating device according to some embodiments of the present disclosure.

FIG. 2 is a flow chart illustrating a prompt message generating method according to some embodiments of the present disclosure.

FIG. 3 is a schematic diagram illustrating an example of an operation shown in FIG. 2 according to some embodiments of the present disclosure.

FIG. 4 is a schematic diagram illustrating an example of two operations shown in FIG. 2 according to some embodiments of the present disclosure.

FIG. 5 is a schematic diagram illustrating an example of an operation shown in FIG. 2 according to some embodiments of the present disclosure.

FIG. 6 is a schematic diagram illustrating an application example of a prompt message generating device according to some embodiments of the present disclosure.

FIG. 7 is a schematic diagram illustrating a prompt message generating device according to some embodiments of the present disclosure.

### DETAILED DESCRIPTION

The following will explain a prompt message generating method and a device thereof and a non-transitory computer-readable storage medium provided by the embodiments of the present disclosure. However, these embodiments are not intended to limit the invention to be implemented in any environment, application or manner as described in these embodiments. Therefore, the description of the embodiments is only for the purpose of explaining the present invention and is not used to limit the scope of the present invention. It should be understood that in the following embodiments and drawings, elements not directly related to the present invention have been omitted and not shown, and the size of each element and the size ratio between elements are only for illustration and are not intended to limit the range of the present invention.

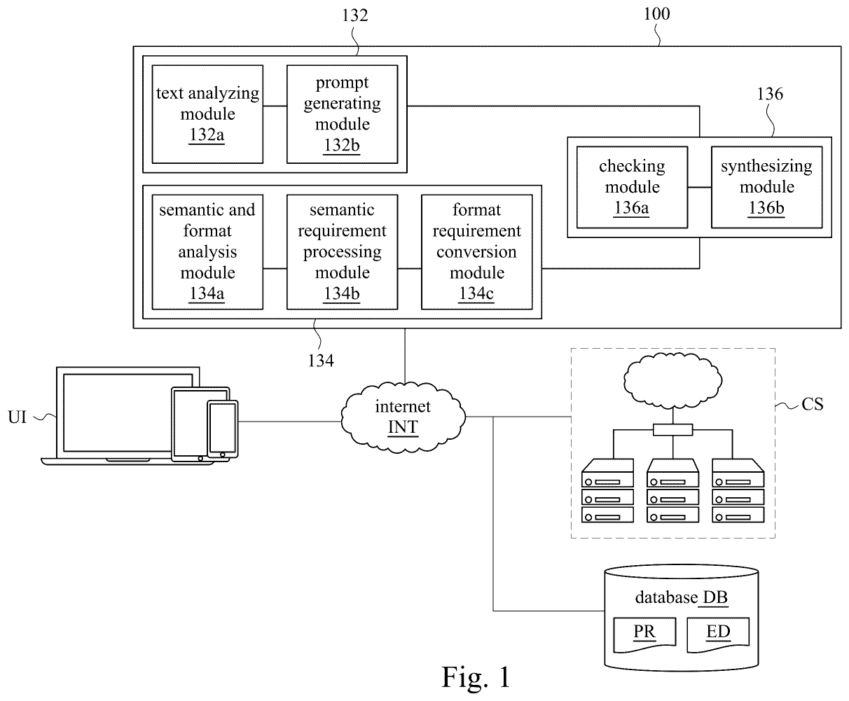

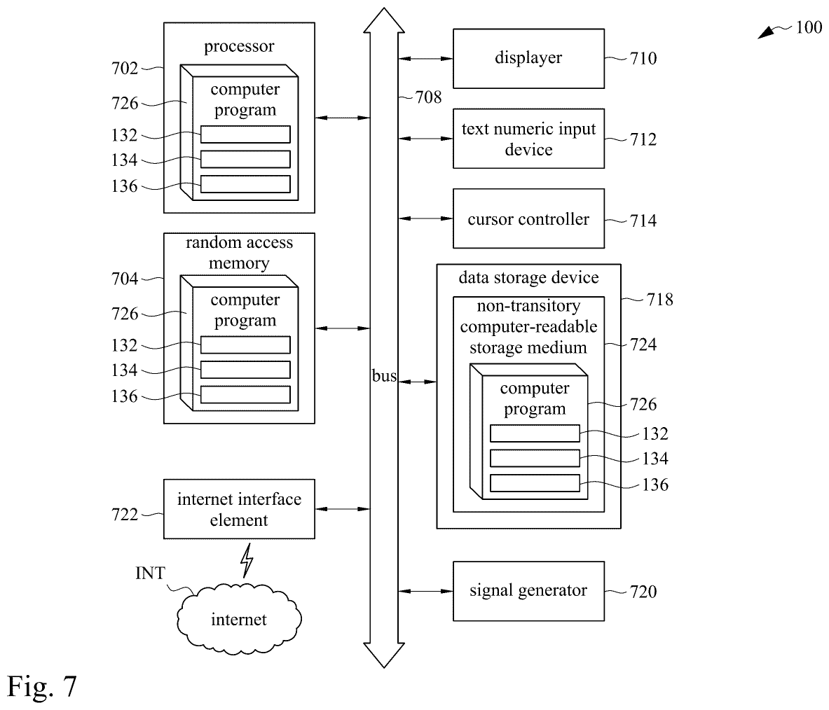

Reference is made to FIG. 1. FIG. 1 is a schematic diagram illustrating a prompt message generating device 100 according to some embodiments of the present disclosure. The detailed structure of the prompt message generating device 100 will be explained with reference to FIG. 7.

The prompt message generating device 100 is configured to execute a task prompt generating module 132, a task example generating module 134 and an output synthesizing module 136. The output of the task prompt generating module 132 serves as part of the input to the output synthesizing module 136, and the output of the task example generating module 134 serves as part of the input to the output synthesizing module 136. The term “module” herein refers to one or more computer programs, which are stored in a computer-readable storage medium, can be loaded into random access memory, and executed by the processor.

The task prompt generating module 132 includes a text analyzing module 132a and a prompt generating module 132b. The output of the text analyzing module 132a serves as the input to the prompt generating module 132b.

The task example generating module 134 includes a semantic and format analysis module 134a, a semantic requirement processing module 134b and a format requirement conversion module 134c. The output of the semantic and format analysis module 134a serves as the input to the semantic requirement processing module 134b, and the output of the semantic requirement processing module 134b serves as the input to the format requirement conversion module 134c.

The output synthesizing module 136 includes a checking module 136a and a synthesizing module 136b. The output of the checking module 136a serves as the input to the synthesizing module 136b.

It should be noted that the embodiment shown in FIG. 1 is provided for illustrative purposes only, and the embodiments of the present disclosure are not limited thereto.

As illustrated in FIG. 1, in some embodiments, the prompt message generating device 100 is connected to the user device UI, the cloud server (CS) and the database DB via internet INT. In some embodiments, the database DB stores predefined rules PR and text example data ED. In some embodiments, a Large Language Model may be included in the cloud server CS.

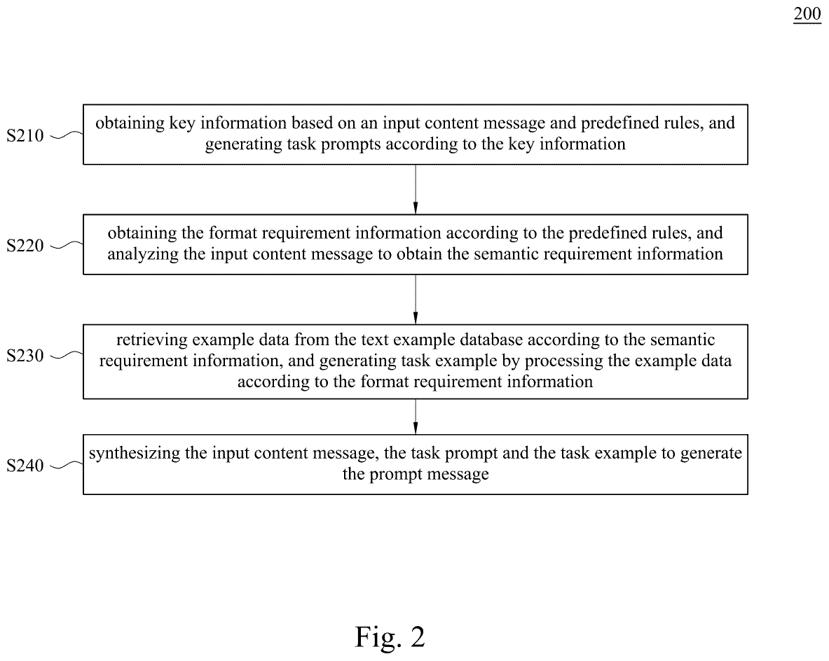

Reference is made to FIG. 2. In order to further understand the present invention, the detailed operation of the prompt message generating device 100 will be discussed in reference to the embodiment shown in FIG. 2. FIG. 2 is a flow chart illustrating a prompt message generating method 200 according to some embodiments of the present disclosure. It should be noted that the prompt message generating method 200 can be applied to an electronic device having the same or similar structure as the prompt message generating device 100 shown in FIG. 1. In order to simplify the following description, the prompt message generating method 200 in some embodiments of the present disclosure will be described by taking the embodiment shown in FIG. 1 as an example. However, the present disclosure is not limited to application of the embodiment shown in FIG. 1. As shown in FIG. 2, the prompt message generating method 200 includes operations S210 to S240.

In operation S210, key information is obtained based on an input content message and predefined rules, and task prompts are generated according to the key information.

In some embodiments, operation S210 is performed by the task prompt generating module 132 in FIG. 1. In some embodiments, the prompt message generating device 100 in FIG. 1 receives the input content message transmitted by the user device UI. The text analyzing module 132a of the task prompt generating module 132 analyzes the input content message to obtain key information based on the input content message and the predefined rules. Then the prompt generating module 132b generates at least one task prompt according to the key information.

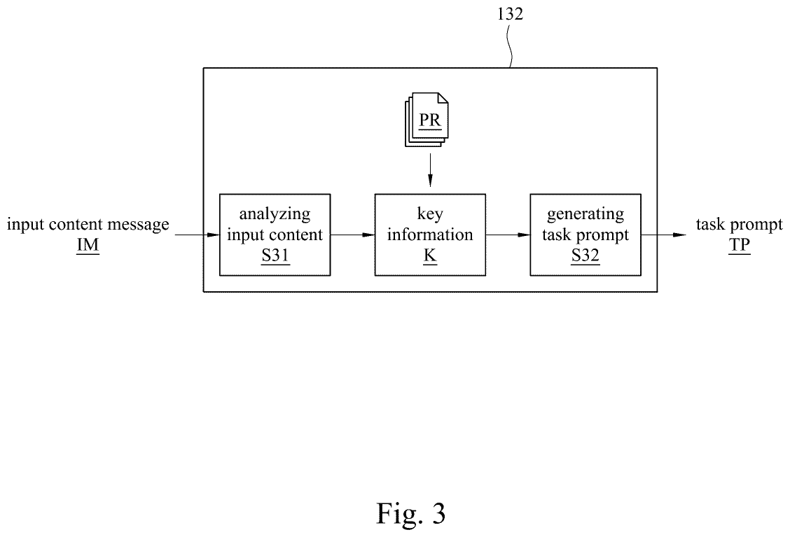

Reference is made to FIG. 3 together. FIG. 3 is a schematic diagram illustrating an example of operation S210 shown in FIG. 2 according to some embodiments of the present disclosure. As illustrated in FIG. 3, after the task prompt generating module 132 receives the input content message IM, the task prompt generating module 132 performs operation S31 (analyzing input content) to analyze the input content message IM, and to obtain key information K based on the input content message IM and predefined rules PR. Next, the task prompt generating module 132 performs operation S32 (generating task prompts) to generate task prompts TP according to the key information K.

In some embodiments, predefined rules PR include, but are not limited to, basic principles, application task type, application attributes and data formatting.

For example, when the usage scenario of the prompt message generating device 100 is “the user uses an academic English translation system with a Large Language Model as the core engine”, the predefined rules PR can include: 1. basic principles: including “source language” and “target language”, with the target language being English. 2. Application task type: machine translation. 3. Application attributes: academic English. 4. Data formatting: None.

The predefined rules PR as mentioned above is only used for illustration purposes, and the embodiments of the present disclosure are not limited to the above.

In some embodiments, when analyzing the input content message IM, the text analyzing module 132a performs at least one of several semantic analysis tasks to obtain key information K. In some embodiments, the semantic analysis tasks include, but are not limited to emotion recognition, keyword extraction, intent detection, named entity recognition, and language detection.

For example, in one embodiment, according to the input content message IM “Please help me with the following academic translation: Utilize Fourier Transform”, the key information K generated by text analyzing module 132a includes: 1. Emotion recognition: No emotion detected. 2. Keyword extraction: Fourier Transform. 3. Intent detection: Translation. 4. Named entity recognition: None identified. 5. Language detection: English.

In some embodiments, text analyzing module 132a is further configured to analyze input content message IM according to predefined rules PR to obtain key information K. For example, in an embodiment, when the context is a listener chatbot, the predefined rules PR include emotion recognition and role recognition. Suppose the input content message IM includes “I feel so frustrated, my boss scolded me”. The text analyzing module 132a analyzes the input content message IM based on the predefined rules PR to obtain the following key information K: Emotion recognition [negative], Role [boss]. According to the above key information K, the task prompt TP generated by the prompt generating module 132b can be: “Please respond in Chinese and express empathy”.

For another example, in one another embodiment, when the context is an English translation system, the predefined rules PR includes language identification. Suppose the input content message IM contains “I feel so frustrated, my boss scolded me ( [symbol] , [symbol] )”. The text analyzing module 132a analyzes the input content message IM based on the predefined rules PR and obtains the following key information K: Language recognition [Traditional Chinese]. According to the above key information K, the task prompt TP generated by the prompt generating module 132b can be: “Please translate from Traditional Chinese to English”.

In some embodiments, the text analyzing module 132a of the task prompt generating module 132 analyzes the input content message IM to obtain the key information K. Then the prompt generating module 132b generates at least one task prompt TP according to key information K and predefined rules PR. Two different scenarios will be given as examples below.

In an embodiment, assume that the situation is an academic English translation system, and the input content message IM includes “The weather is very good today. ( [symbol] )” based on predefined rules PR. The text analyzing module 132a can obtain key information K including: The application is academic English translation, and the target translation language is English. The text analyzing module 132a obtains key information K including “user input language is Traditional Chinese” based on input content message IM. Based on the above key information K, the task prompt TP generated by the prompt generating module 132b includes “Please translate from Traditional Chinese to English” and “English words are academic words”.

In one another embodiment, Assume that the situation is a listening chatbot and the input content message IM includes “I'm so frustrated, I have to work overtime again.” Based on the predefined rules PR, the text analyzing module 132a can obtain key information K including “application for several rounds of dialogue, with empathy.” The text analyzing module 132a obtains key information K including “emotion is frustration” and “event is overtime” based on the input content message IM. Based on the above key information K, the task prompt TP generated by the prompt generating module 132b includes “task is a multi-round dialogue”, “reply with empathy”, “comfort the user's frustration”, “ask why they have to work overtime”, and “ensure the output does not contain discriminatory language.”

In some embodiments, when the prompt generating module 132b generates the task prompt TP according to the key information K and the predefined rules PR, the prompt generating module 132b is further configured to assign a confidence score to the task prompt TP. For example, in an embodiment, the prompt generating module 132b generates a first task prompt and a second task prompt according to the key information K and the predefined rules PR. The prompt generating module 132b assigns a first confidence score to the first task prompt and a second confidence score to the second task prompt.

In some embodiments, the text analyzing module 132a can perform analysis using a Large Language Model and can be implemented by commonly used analysis methods in the traditional natural language processing field (For example, keyword extraction, named entity recognition) or any other text processing method. In some embodiments, the prompt generating module 132b can be implemented by any text generation method (such as: Large Language Model, template-based slot filling, and rule-based generation).

Reference is made to FIG. 2 again. In operation S220, the format requirement information is obtained according to the predefined rules, and the input content message is analyzed to obtain the semantic requirement information.

In some embodiments, operation S220 is performed by the semantic and format analysis module 134a of the task example generating module 134 in FIG. 1. In some embodiments, the semantic and format analysis module 134a can perform analysis using the Large Language Model, using commonly used analysis methods in the traditional natural language processing field (For example, keyword extraction, named entity recognition) or any other text processing method.

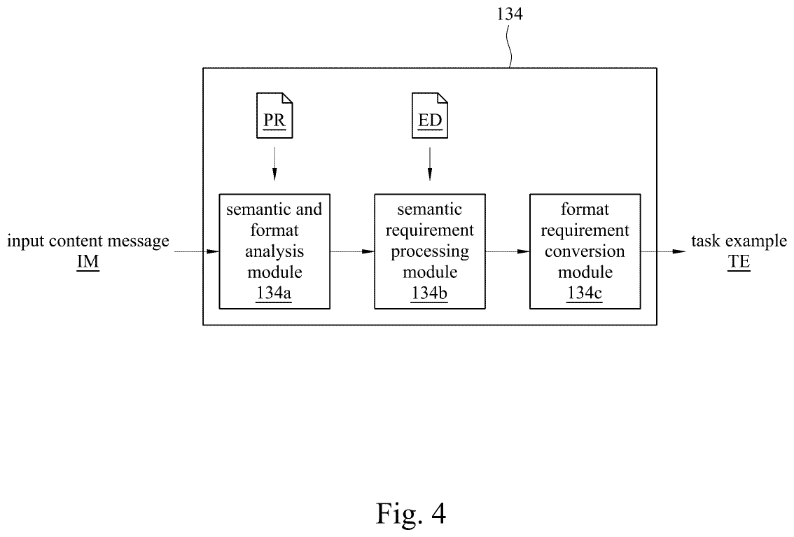

Reference is made to FIG. 4 together. FIG. 4 is a schematic diagram illustrating an example of operations S220 and S230 shown in FIG. 2 according to some embodiments of the present disclosure. As illustrated in FIG. 4, the semantic and format analysis module 134a obtains the format requirement information according to the predefined rules PR, and the semantic and format analysis module 134a analyzes the input content message IM to obtain the semantic requirement information.

For example, in an embodiment, the input content message IM includes “Please translate into business English.” Based on the input content message IM, the semantic and format analysis module 134a determines the semantic requirement information as “Translation action, conforming to business English standards” based on the input content message IM.

In one another embodiment, the input content message IM includes “Please explain the butterfly effect in a bullet-point format and response in traditional Chinese”. Based on the input content message IM, the semantic and format analysis module 134a obtains semantic requirement information as “Question-and-answer action, response should follow a bullet-point format and be in Traditional Chinese”.

In one another embodiment, the predefined rules PR includes “data formatting”, and the semantic and format analysis module 134a determines the format requirement information as “json format” based on predefined rules PR.

In operation S230, example data is retrieved from the text example database according to the semantic requirement information, and task example is generated by processing the example data according to the format requirement information.

In some embodiments, operation S230 is performed by the semantic requirement processing module 134b and the format requirement conversion module 134c of the task example generating module 134 as shown in FIG. 1. Reference is made to FIG. 4 together. As illustrated in FIG. 4, the semantic requirement processing module 134b retrieves at least one example data from the text example database ED according to the semantic requirement information. Then the format requirement conversion module 134c processes at least one example data according to the format requirement information to generate at least one task example TE.

In some embodiments, the semantic requirement processing module 134b is further configured to retrieve at least one example data through similarity calculation.

In some embodiments, according to the input content message, semantic requirement processing module 134b determines the application task type corresponding to the input content message IM through application classification. When the application task type corresponding to the input content message IM matches or aligns with the application task type in the predefined rules PR, the semantic requirement processing module 134b retrieves the example data associated with the application task type from the text example database ED.

In some embodiments, the semantic requirement processing module 134b further filters the example data. For example, the semantic requirement processing module 134b performs similarity calculation between example data and input content message IM, retains those with higher similarity (For example, the similarity is higher than the preset similarity threshold), and discards those with lower similarity.

In some embodiments, text example database ED includes: 1. Open source data publicly available on the internet. 2. Data created based on proprietary corpus. 3. Licensed or purchased text materials. 4. Compiled and verified historical data.

In some embodiments, text example database ED assigns tags indicating the application type and attributes (such as format and purpose) corresponding to each example. Application types include but are not limited to question-answering, dialogue, translation, and analysis. For example, a sample entry may be tagged with application (conversation), format (sentence), language (Chinese), purpose (care), and purpose (chat).

In some embodiments, for the example data retrieved by the semantic requirement processing module 134b, the format requirement conversion module 134c performs format conversion process based on the format requirement obtained by the semantic and format analysis module 134a to generate a task example TE.

For example, the format requirement specified in the predefined rules PR is “application output format must be JSON”. The task example TE retrieved by semantic requirement processing module 134b is as follows: “Q: Please explain photosynthesis A: Plants use light energy to convert carbon dioxide and water into oxygen. Photosynthesis is the most important chemical reaction in the biological world, among which the three most important elements are light energy, water, and carbon dioxide.” Based on the format requirement, the format requirement conversion module 134c needs to convert the output format into the specified format. For example, it converts a plain text sentence format into JSON format. After conversion through format requirement conversion module 134c, the converted task example TE is as follows: “Q: Please explain photosynthesis A: {” text “: “Plants use light energy to convert carbon dioxide and water into oxygen. Photosynthesis is the most important chemical reaction in the biological world, among which the three most important elements are light energy, water, and carbon dioxide.”}”.

Reference is made to FIG. 2 again. In operation S240, the input content message, the task prompt and the task example are synthesized to generate the prompt message. In some embodiments, operation S240 is performed by the output synthesizing module 136 in FIG. 1.

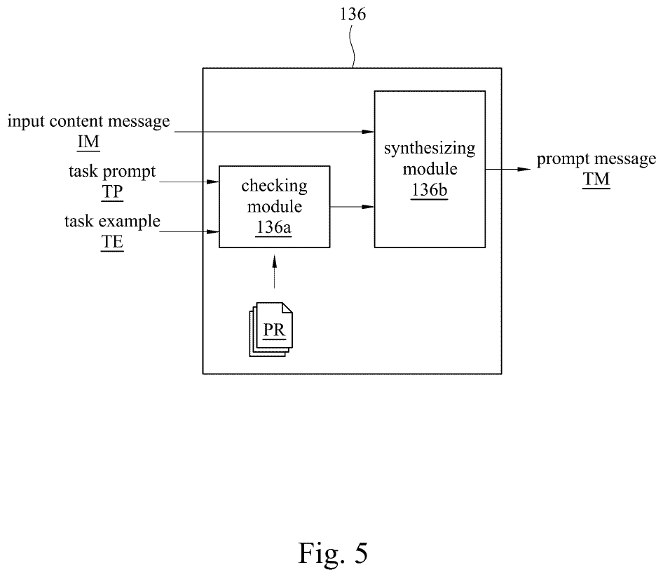

Reference is made to FIG. 5 together. FIG. 5 is a schematic diagram illustrating an example of operation S240 shown in FIG. 2 according to some embodiments of the present disclosure. As illustrated in FIG. 5. After the checking module 136a checks the task prompt TP generated by the task prompt generating module 132 in FIG. 1 and the task example TE generated by the task example generating module 134 in FIG. 1, the checking module 136a transmits the checked task prompt TP and the task example TE to the synthesizing module 136b in FIG. 1, then the synthesizing module 136b synthesizes the input content message IM, the task prompt TP and the task example TE to generate the prompt message TM.

In some embodiments, the checking module 136a determines whether there is a conflict or contradictory task prompt in the task prompt TP generated by the task prompt generating module 132.

In some embodiments, when there is a conflict among several task prompts TP, the checking module 136a retains the task prompt that originates from predefined rules PR or conforms predefined rules PR. If none of the several conflicting task prompts TP originate from the predefined rules PR, or if all of them originate from the predefined rules PR, the checking module 136a evaluates the confidence scores of the several conflicting task prompts TP and retains the task prompt TP with the highest confidence score.

For example, if the task prompt TP generated by the task prompt generating module 132 includes a first task prompt (please translate into English) and a second task prompt (please response in Chinese), the checking module 136a retains the first task prompt or the second task prompt that conforms to the predefined rules PR, and the checking module 136a deletes the first task prompt or the second task prompt that does not conform to the predefined rules PR.

If both the first task prompt and the second task prompt both conform the predefined rules PR or if neither conforms the predefined rules PR, the checking module 136a retains the one with higher confidence score between the first task prompt and the second task prompt.

In some embodiments, the checking module 136a is further configured to determine whether the task prompt TP and the task example TE are inconsistent. For example, when the task prompt is “Output in Traditional Chinese” and the task example TE is “This is an example . . . ”, since the task example TE is output in English instead of Traditional Chinese, the checking module 136a determines that the task prompt TP and the task example TE are inconsistent. In some embodiments, the checking module 136a deletes this task example TE. In some other embodiments, the checking module 136a translates the task example TE into Traditional Chinese.

In some embodiments, the checking module 136a is further configured to detect whether the task prompt TP or the task example TE include biased or discriminatory content. If the checking module 136a detects that the task prompt TP or the task example TE includes inappropriate content, the checking module 136a will remove the task prompt TP or the task example TE including the inappropriate content.

In some embodiments, the checking module 136a can perform analysis using the Large Language Model, applying common semantic analysis methods in the traditional natural language processing field (For example, keyword extraction, named entity recognition), or any text processing method.

In some embodiments, the synthesizing module 136b combines the input content message IM with the task prompt TP and the task example TE that have passed the checking and filtering by the checking module 136a, generates a prompt message TM, and outputs the prompt message TM.

In some embodiments, the prompt message TM includes any combination of the following three types: 1. input content message IM, task prompt TP and task example TE. 2. input content message IM and task prompt TP. 3. input content message IM and task example TE.

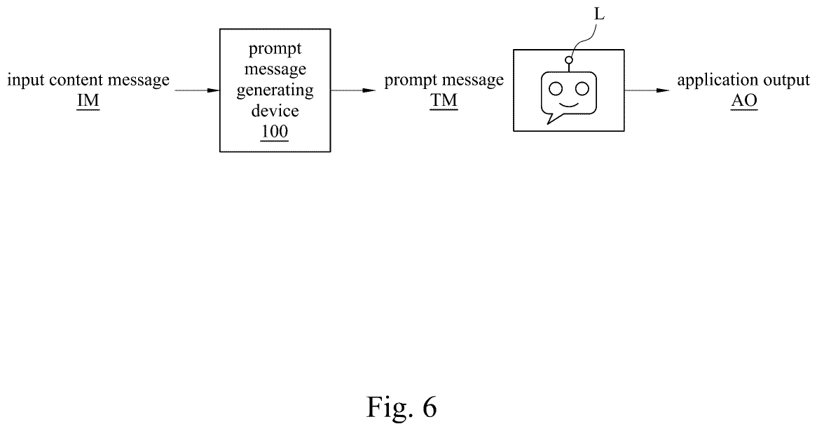

Reference is made to FIG. 6 together. FIG. 6 is a schematic diagram illustrating an application example of a prompt message generating device 100 according to some embodiments of the present disclosure. In some embodiments, the prompt message TM serves as the output of the prompt message generating device 100. The prompt message TM serves as the actual output data generated based on the input content message IM and is then fed into the Large Language Model L. The Large Language Model L then generates the corresponding application output AO based on the prompt message TM.

Reference is made to FIG. 7. FIG. 7 is a schematic diagram illustrating a prompt message generating device 100 according to some embodiments of the present disclosure. In some embodiments, the prompt message generating device 100 includes a processor 702, a random access memory 704, an internet interface element 722, a display 710, a text numeric input device 712, a cursor controller 714, a data storage device 718, a non-transitory computer-readable storage medium 724, a signal generator 720 and a bus 708. The above processor 702, random access memory 704, internet interface element 722, display 710, text numeric input device 712, cursor controller 714, data storage device 718, non-transitory computer-readable storage medium 724, signal generator 720 transmit messages, signals or data via the bus 708.

In some embodiments, the internet interface element 722 is connected to the user device UI, the Large Language Model L and the database DB as shown in FIG. 1 via internet INT. In some embodiments, the non-transitory computer-readable storage medium 724 in the data storage device 718 stores computer program 726. The computer program 726 includes task prompt generating module 132, task example generating module 134 and output synthesizing module 136. The computer program 726 (and its task prompt generating module 132, task example generating module 134 and output synthesizing module 136) can be loaded into the random access memory 704, and can be read and performed by the processor 702 to perform the prompt message generating method 200 as shown in FIG. 2.

In some embodiments, the processor 702, for example, may be implemented by one or more processing circuits. For example, Central processing circuit and/or micro processing circuit, but the embodiments of the present disclosure are not limited thereto. In some embodiments, the random access memory 704 can be a dynamic random access memory (DRAM), or a static random access memory (SRAM). Data storage device 718 may include one or more non-transitory computer-readable storage medium 724. The non-transitory computer-readable storage medium 724 can be read-only memory (ROM), flash memory, disk drive, hard disk, optical disk, pen drive, tape, database accessible from the internet, and/or any storage media with the same function that a person of ordinary skill in the art to which this disclosure belongs can think of.

In summary, the embodiments of the present disclosure provide a non-transitory computer-readable storage medium and a prompt message generating method. Based on the input content message and the predefined rules, the prompt message for Large Language Model is automatically generated. There is no need for manual intervention to create prompt messages, nor does it require manual intervention to select prompt examples, which reduces the frequency of fine-tuning prompt messages based on applications, and thereby accelerates the development of text-related applications. Furthermore, the embodiments of the present disclosure can be applied to any text-related application projects with Large Language Model as the core engine, speeding up the application development process. For advanced applications in the text field, such as intelligent question answering and chatbots, automatically generated prompt messages allow users to experience more natural interactions—rather than rigid, rule-based responses—and enable more seamless integration with application contexts, thereby improving the user experience.

It should be noted that, unless otherwise stated, there is no specific order among the operations of the above prompt message generating method 200. Furthermore, each operation can also be performed concurrently, or the execution times may at least partially overlap.

Further, according to various embodiments of the present disclosure, the operation of the prompt message generating method 200 may be appropriately added, replaced, and/or omitted.

Various functional modules, components or blocks have been described herein. As those skilled in the art will understand, the modules or functional blocks will preferably be implemented through circuits (Whether a dedicated circuit or a general-purpose circuit, operating under the control of one or more processing circuits and coded instructions). Circuits often include transistors or other circuit elements that are configured to control the circuit in accordance with the functions and operations described herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A non-transitory computer-readable storage medium, wherein the non-transitory computer-readable storage medium stores one or more computer programs, and the one or more computer programs can be performed by one or more processors to perform a prompt message generating method, wherein the prompt message generating method comprises:
obtaining at least one key information based on an input content message and a predefined rule, and generating at least one task prompt according to the at least one key information;
obtaining a format requirement information according to the predefined rule, and analyzing the input content message to obtain a semantic requirement information;
retrieving at least one example data from a text example database according to the semantic requirement information, and processing the at least one example data according to the format requirement information to generate at least one task example; and
synthesizing the input content message, the at least one task prompt and the at least one task example to generate a prompt message.

2. The non-transitory computer-readable storage medium of claim 1, wherein the predefined rule comprises basic principles, application task type, application attributes and data formatting.

3. The non-transitory computer-readable storage medium of claim 1, wherein analyzing the input content message comprises performing at least one of a plurality of semantic analysis tasks, wherein the plurality of semantic analysis tasks comprise emotion recognition, keyword extraction, intent detection, named entity recognition and language detection.

4. The non-transitory computer-readable storage medium of claim 1, wherein the at least one task prompt comprises a first task prompt and a second task prompt, wherein the prompt message generating method further comprises:
assigning a first confidence score to the first task prompt and a second confidence score to the second task prompt.

5. The non-transitory computer-readable storage medium of claim 4, wherein the prompt message generating method further comprises:
retaining the first task prompt or the second task prompt that conforms with the predefined rule when the first task prompt and the second task prompt conflict with each other.

6. The non-transitory computer-readable storage medium of claim 4, wherein the prompt message generating method further comprises:
retaining the first task prompt when the first task prompt and the second task prompt conflict with each other and the first confidence score is higher than the second confidence score.

7. The non-transitory computer-readable storage medium of claim 1, wherein the prompt message generating method further comprises:
retrieving the at least one example data through a similarity calculation.

8. The non-transitory computer-readable storage medium of claim 1, wherein the prompt message comprises at least two of the following: the input content message, the at least one task prompt and the at least one task example.

9. A prompt message generating method, comprising:
obtaining at least one key information based on an input content message and a predefined rule, and generating at least one task prompt according to the at least one key information;
obtaining a format requirement information according to the predefined rule, and analyzing the input content message to obtain a semantic requirement information;
retrieving at least one example data from a text example database according to the semantic requirement information, and processing the at least one example data according to the format requirement information to generate at least one task example; and
synthesizing the input content message, the at least one task prompt and the at least one task example to generate a prompt message.

10. The prompt message generating method of claim 9, wherein the predefined rule comprises basic principles, application task type, application attributes and data formatting.

11. The prompt message generating method of claim 9, wherein analyzing the input content message comprises performing at least one of a plurality of semantic analysis tasks, wherein the plurality of semantic analysis tasks comprise emotion recognition, keyword extraction, intent detection, named entity recognition, language detection.

12. The prompt message generating method of claim 9, wherein the at least one task prompt comprises a first task prompt and a second task prompt, wherein the prompt message generating method further comprises:
assigning a first confidence score to the first task prompt and a second confidence score to the second task prompt.

13. The prompt message generating method of claim 12, further comprising:
retaining the first task prompt or the second task prompt that conforms with the predefined rule when the first task prompt and the second task prompt conflict with each other.

14. The prompt message generating method of claim 12, further comprising:
retaining the first task prompt when the first task prompt and the second task prompt conflict with each other and the first confidence score is higher than the second confidence score.

15. The prompt message generating method of claim 9, further comprising:
obtaining the at least one example data through a similarity calculation.

16. The prompt message generating method of claim 9, wherein the prompt message comprises at least two of the input content message, the at least one task prompt and the at least one task example.
